(19) United States
(12) Patent Application Publication
(10) Pub. No.: US 2010/0229565 A1
(43) Pub. Date: Sep. 16, 2010

(54) WALL OF A ROCKET ENGINE

(76) Inventor: Arne Boman, Trollhattan (SE)

Correspondence Address: WRB-IP LLP, 801 N. Pitt Street, Suite 123, ALEXANDRIA, VA, 22314, US

(21) Appl. No.: 12/520,094

(22) PCT Filed: Dec. 19, 2006
(86) PCT No.: PCT/SE06/01448

§ 371 Date: Jan. 10, 2010

(51) Int. Cl. F02C 3/14

(52) U.S. Cl. 60/752

(57) ABSTRACT

A wall configured to withstand a high thermal load, said wall having a surface that is turned away from a heat source and provided with at least one strengthening element that, from a base portion thereof, protrudes from said surface. Said at least one strengthening element presents a decreasing width from its base portion towards a top portion thereof. The wall is an engine wall of a thrust nozzle of a rocket engine.

### BACKGROUND AND SUMMARY

The present invention relates to a wall configured to withstand a high thermal load, said wall having a surface that is turned away from a heat source and provided with at least one strengthening element that, from a base portion thereof, protrudes from said surface, in a direction away from said heat source. The wording high thermal load should be interpreted as an order of magnitude of the thermal load that arises in an engine wall during engine operation. The invention is especially directed to an engine wall (and especially a thrust chamber wall) capable of withstanding the extreme thermal loads arising during operation of a rocket engine, but also other applications are feasible.

Thus, the invention especially relates to a rocket engine provided with such a wall.

Preferably, the engine wall is a thrust nozzle wall of a rocket engine. Accordingly, it may be of considerable diameter and may have a conical shape. During engine operation, it will be subjected to considerable heat affection from the hot gases passing through the thrust nozzle.

The thermal load on a thrust nozzle wall of a rocket engine is dependent of the conditions on the hot side, the inside, where a flame or hot gas flows along the inside of the wall.

In many cases, the thrust nozzle wall is cooled by means of radiation. Thereby, generally all of the heat emitted from the wall is emitted by means of radiation, mainly from the outer surface of the nozzle to the surrounding, but also to some extent from the inside to the surrounding. The temperature adopted by the wall is dependent on the efficiency of the cooling on the outside of the nozzle wall. Thereby, the emissivity and the wall area play a role as important parameters.

Contemporary nozzle walls are often provided with strengthening element or stiffeners on the outside thereof. Such strengthening elements may have the shape of rims 8 extending in the circumferential direction, i.e. crosswise to the longitudinal direction of the nozzle, around the nozzle wall. The objective of such elements is to increase the rigidity of the nozzle wall, and thereby to prevent buckling thereof. Typically, the strengthening elements are formed by discrete flanges of considerable height, as measured from the part of the wall from which they project. Normally, they are also made of the same material as the part of the wall from which the project.

It is desirable to present a wall that combines a high strength and buckling resistance with an improved ability of conducting and emitting heat.

According to an aspect of the present invention, a wall is provided which is characterised in that said at least one strengthening element presents a decreasing width from its base portion towards a top portion thereof. The diminishing width is of a general nature. A local increase of said width at any site along the path from the base portion to the top portion may occur, as long as the general tendency is a diminishing of said width. Thanks to an increased view factor, the ability of the strengthening elements to transfer heat from the part of the wall with which they are connected to the surrounding environment is thus increased.

According to one embodiment, at least one strengthening element presents a continuously decreasing width from its base portion towards its top portion.

According to one embodiment, said at least one strengthening element has two opposite flanks extending from the top portion towards the base portion, and that at least one of said flanks slopes towards the base portion.

According to one embodiment, said at least one strengthening element presents a stepwise decreasing width from its base portion towards its top portion.

According to one embodiment, the view factor of said at least one strengthening element is 0.6 or more. Strengthening elements with a large height/width ratio will present a more uneven temperature profile during engine operation than will corresponding elements of lower height/width ratio. The tip of such elements with large height/width ratio will be comparatively cold in relation to the root part thereof, something which is unfavourable if a maximum radiation of heat from the strengthening element is to be achieved. However, since the strengthening elements may have different shapes, the height/width ratio might not be a fully relevant way of defining this relation in all cases. In comparison thereto, the view factor is then considered a more relevant term. For a simple design comprising two adjacent strengthening elements of rectangular shape with mutually opposing surfaces and projecting from a wall surface, the view factor of the wall surface is approximately equal to (area of opening between the tops of the adjacent elements/(area of said opening+area of the opposing surfaces of the strengthening elements). For more complex shaped elements, the following view factor may be calculated upon basis of the following theories. Accordingly, for a given shape, height and distance between the strengthening elements of the invention, a person will be able to calculate a specific view factor of the wall.

The heat emitted by a blackbody (per unit time) at an absolute temperature of T is given by the Stefan-Boltzmann Law of thermal radiation,

\dot{Q}=AσT^{A}=AE_{blackbody}

where \dot{Q} has units of Watts, A is the total radiating area of the blackbody, and s is the Stefan-Boltzmann constant.

A small blackbody at absolute temperature T enclosed by a much larger blackbody at absolute temperature Te will transfer a net heat flow of,

\dot{Q}=Aσ(T^{A}−Tₑ^{A})

The small blackbody still emits a total heat flow given by the Stefan-Boltzmann law. However, the small blackbody also receives and absorbs all the thermal energy emitted by the large enclosing blackbody, which is a function of its temperature Te. The difference in these two heat flows is the net heat flow lost by the small blackbody.

Bodies that emit less thermal radiation than a blackbody have surface emissivities e less than 1. If the surface emissivity is independent of wavelength, then the body is called a “gray” body, in that no particular wavelength (or color) is favored. The net heat transfer from a small gray body at absolute temperature T with surface emissivity e to a much larger enclosing gray (or black) body at absolute temperature Te is given by,

\dot{Q}=εAσ(T^{A}−Tₑ^{A})

The above equations for blackbodies and graybodies assumed that the small body could see only the large enclosing body and nothing else. Hence, all radiation leaving the small body would reach the large body. For the case where two objects can see more than just each other, then one must introduce a view factor F and the heat transfer calculations become significantly more involved.

The view factor F12 is used to parameterize the fraction of thermal power leaving object 1 and reaching object 2. Specifically, this quantity is equal to,

\dot{Q}_{1→2}=A₁F₁₂σT₁⁴

Likewise, the fraction of thermal power leaving object 2 and reaching object 1 is given by,

\dot{Q}_{2→1}=A₂F₂₁σT₂⁴

The case of two blackbodies in thermal equilibrium can be used to derive the following reciprocity relationship for view factors,

A₁F₁₂=A₂F₂₁

Thus, once one knows F12, F21 can be calculated immediately.

Radiation view factors can be analytically derived for simple geometries and are tabulated in several references on heat transfer (e.g. Holman, 1986). They range from zero (e.g. two small bodies spaced very far apart) to 1 (e.g. one body is enclosed by the other).

The heat flow transferred from Object 1 to Object 2 where the two objects see only a fraction of each other and nothing else is given by,

$$\dot{Q} = {( \frac{1 - {ɛ}_{1}}{{ɛ}_{1}} + \frac{1}{{F}_{12}} + ( \frac{1 - {ɛ}_{2}}{{ɛ}_{2}} ) \frac{{A}_{1}}{{A}_{2}} )}^{- 1} {A}_{1} σ ( {T}_{1}^{4} - {T}_{2}^{4} )$$

This equation demonstrates the usage of F12, but it represents a non-physical case since it would be impossible to position two finite objects such that they can see only a portion of each other and “nothing” else. On the contrary, the complementary view factor (1-F12) cannot be neglected as radiation energy sent in those directions must be accounted for in the thermal bottom line.

A more realistic problem would consider the same two objects surrounded by a third surface that can absorb and readmit thermal radiation yet is non-conducting. In this manner, all thermal energy that is absorbed by this third surface will be readmitted; no energy can be removed from the system through this surface. The equation describing the heat flow from Object 1 to Object 2 for this arrangement is,

$$\dot{Q} = {( \frac{1 - {ɛ}_{1}}{{ɛ}_{1}} + \frac{{A}_{1} + {A}_{2} - 2 {A}_{1} {F}_{12}}{{A}_{2} - {{A}_{1} ( {F}_{12} )}^{2}} + ( \frac{1 - {ɛ}_{2}}{{ɛ}_{2}} ) \frac{{A}_{1}}{{A}_{2}} )}^{- 1} {A}_{1} σ ( {T}_{1}^{4} - {T}_{2}^{4} )$$

According to one embodiment, said wall comprises at least two neighbouring strengthening elements, wherein there is a gap between the base portions of said elements.

According to one embodiment, the wall comprises at least two neighbouring strengthening elements, wherein said elements are joined at their base portions.

According to one embodiment, said at least two neighbouring strengthening elements are joined at their base portions along a major part of said elements in a longitudinal direction thereof.

According to one embodiment, said at least two neighbouring strengthening elements are joined at their base portions along generally the whole length of said elements.

According to one embodiment, said at least one strengthening element defines a flange that extends in a circumferential direction on said wall, crosswise to a flow direction of hot gases through said channel.

According to one embodiment, said at least one strengthening element extends continuously along the outer periphery of said wall, thereby defining a ring-shaped element.

According to one embodiment, the wall comprises at least two neighbouring strengthening elements that extend generally in parallel with each other.

According to one embodiment, the wall comprises a plurality of strengthening elements and that said strengthening elements covers a substantial part of said surface.

According to one embodiment, the wall comprises a plurality of strengthening elements, wherein said strengthening elements covers a major part of said surface.

According to one embodiment, the wall comprises a plurality of strengthening elements, wherein said strengthening elements covers all of said surface.

According to one embodiment, said at least one strengthening element is coated with a layer that increases the thermal emissivity thereof.

According to one embodiment, the thermal emissivity of said at least one strengthening element is above 0.75.

According to one embodiment, the wall comprises a plurality of strengthening elements that define a corresponding plurality of ridges of different height, and wherein the distance between neighbouring ridges of larger height is larger than the distance between neighbouring ridges of lower height

By presenting such a pattern of interconnected ridges, instead of discrete such ones, of a material of higher thermal conductivity than the part of the wall from which said at least one strengthening element projects, a substantially improved cooling of the engine wall may be achieved.

According to one embodiment, the material of said at least one strengthening element has a higher thermal conductivity than the material of the part of the engine wall from which it protrudes.

According to one embodiment, the part of the wall to which said at least one strengthening element is attached comprises steel, and said strengthening element comprises copper as a main constituent.

According to one embodiment said wall is an engine wall designed so as to delimit a channel in which there is a flow of hot gases during engine operation, said hot gases forming said heat source. Preferably, said wall comprises an inner wall and an outer wall interconnected by a plurality of webs, with ducts extending between said webs.

Further features and advantages of the present invention will be presented in the following detailed description.

### BRIEF DESCRIPTION OF THE DRAWINGS

Preferred embodiments of the present invention will now be described by way of example, with reference to the annexed drawings, on which:

FIG. 1 shows a partially cut side view of a nozzle provided with A wall according to the invention.

FIG. 2 is an enlargement of a part of the engine wall according to FIG. 1,

FIG. 3 is a schematic representation of a cross section of a part of A wall along the line III-III in FIG. 2,

FIG. 4 is a view corresponding to the one of FIG. 2, of a second embodiment of the invention,

FIG. 5 is a view corresponding to the one of FIG. 2, of a third embodiment of the invention,

FIG. 6 is a view corresponding to the one of FIG. 2, of a fourth embodiment of the invention,

FIG. 7 is a view corresponding to the one of FIG. 2, of a fifth embodiment of the invention,

FIG. 8 is a view corresponding to the one of FIG. 2, of a sixth embodiment of the invention, and

FIG. 9 is a view corresponding to the one of FIG. 2, of an embodiment according to prior art.

### DETAILED DESCRIPTION

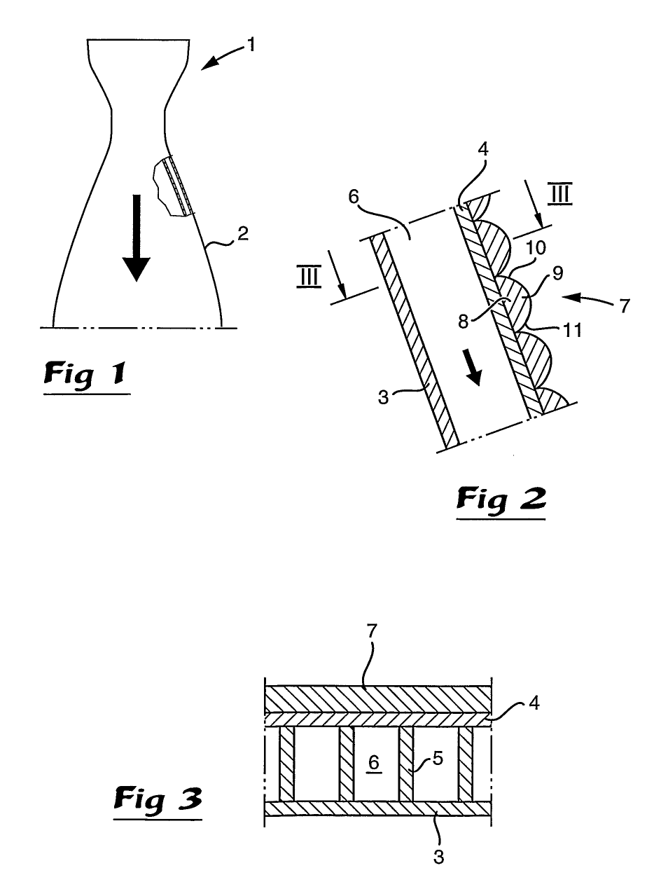

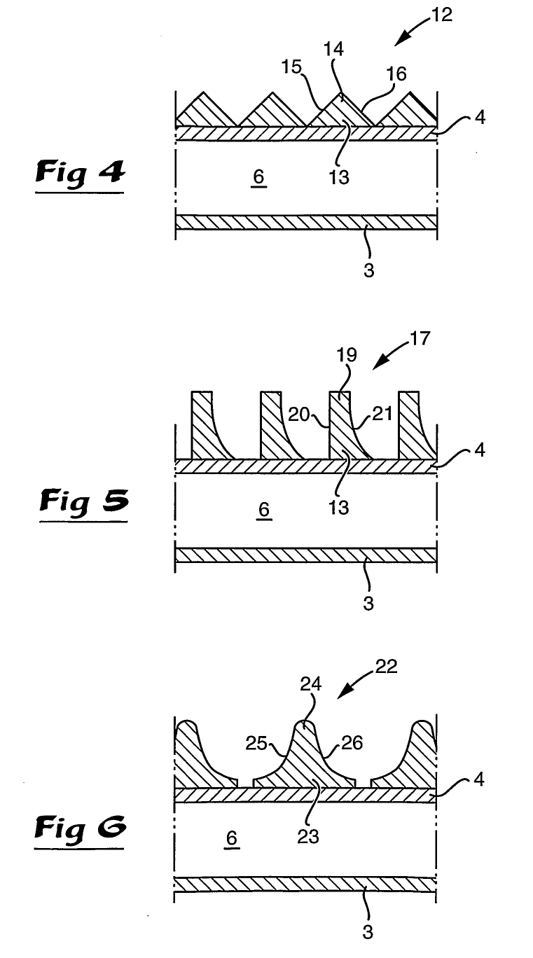

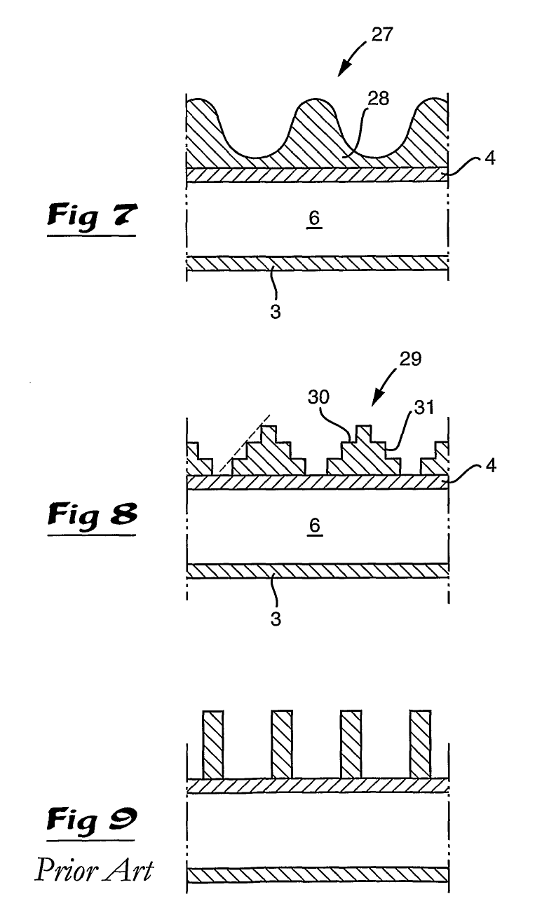

FIGS. 1 and 2 are schematic representations of a thrust nozzle 1 of a rocket engine. The nozzle 1 comprises and is defined by a generally cone-shaped engine wall 2. The engine wall 2 is provided with an inner wall 3, preferably with a thickness of 0.15-2 mm, and an outer wall 4, interconnected by a plurality of webs 5, as shown in FIG. 3. In the space between the inner wall 3 and the outer wall 4 there are ducts 6 that are used for cooling purposes, each duct 6 being delimited by two adjacent webs 5, the inner wall 3 and the outer wall 4. During operation of the engine a cooling medium, preferably the fuel or part of the fuel of the engine, is permitted to flow through the ducts 6 for the purpose of cooling the engine wall 2. This technique applies to satellite launchers and space planes, and also in satellite thrusters, nuclear reactors and high efficiency boilers, and it can also be applied to heat shields or to the nose cones of vehicles travelling at very high speed.

The webs 5 are elongated, extend mainly in the longitudinal direction of the nozzle 1, and act as intermediate walls between adjacent ducts 6. Preferably, the thickness of the webs 5 is constant along their longitudinal direction. Accordingly, since the nozzle 1 is cone-shaped, the width of the ducts 6 increases in the longitudinal direction, i.e. in the flame propagation direction of the engine to which the nozzle is associated.

Reference will now be made to FIG. 2, which shows a first embodiment of the invention. On the outside of the outer wall 4, on the surface thereof turned away from the chamber delimited by the engine wall 2, there are provided a plurality of strengthening elements 7 that, in their longitudinal direction, extend in the circumferential direction of the engine wall 2, thereby defining a plurality of parallel, ring-shaped elements. Preferably, the strengthening elements 7 are made of a material that has a higher thermal conductivity than the material of the underlying part 4 of the engine wall 2 from which they project. Typically, said underlying part of the engine wall 2 may be made of steel, while copper forms a main constituent of the strengthening element or elements 7. By using strengthening elements 7 made of material of higher thermal conductivity than the underlying material, an improved radiative cooling of the engine wall 2 may be obtained.

The strengthening elements 7 project from said surface of the engine wall 2, mainly in a perpendicular direction in relation thereto. The strengthening elements 7 may be regarded as a plurality of rims that extend circumferentially in a transverse direction with regard to the axis of the engine wall 2. Each element 7 has a base portion 8, a top portion 9 and opposite flanks 10, 11. Preferably, also the area between said rims is at least partly, preferably mostly, and most preferably totally covered by a material corresponding to the material of the elements 7. Here, the base portions 8 of neighbouring strengthening elements 7 are interconnected. The inclination angle of the descending and ascending flanks 10, 11 of the elements 7 may change along the respective flanks. For example, as in the embodiment of FIG. 2, it may increase towards the base portion 8. The contour of the descending and ascending flanks 10, 11 of each element 7 may also differ from each other.

Preferably, each strengthening element 7 extend continuously all around the periphery of the engine wall 2. Preferably, the base portions 9 of the neighbouring strengthening elements 7 are interconnected along a substantial length of said elements 7, such that the strengthening elements 7 cover a substantial part of all the intermediate area between the central portions of said elements, preferably a major part all of said area. This correspond to an embodiment in which the cross-section of the embodiment of FIG. 2 is present along the whole circumference of the engine wall 2.

The contour of the interconnected strengthening elements 7, as seen crosswise to the longitudinal direction thereof, follows a continuously ascending and descending line, defining ridges at the top portions 9 thereof and sinks at the base portions 8 thereof, said ridges and sinks being interconnected by the flanks 10, 11. The contour is chosen such that the view factor thereof towards the surrounding is 0.7 or higher. This is a remarkable difference in comparison to strengthening elements of prior art (see FIG. 9), which present separated, discrete flange-like rims that extend perpendicularly from the underlying surface and to such extent that the view factor is well below 0.7. A higher view factor will indicate that, when heat is conducted to the strengthening element or elements 7 through the part of the engine wall 2 from which said elements 7 project, said element or elements 7 will have an improved ability of further conducting the heat away to the surrounding by means of radiation.

FIG. 2 shows an example of a rounded contour of the elements 7, wherein the ascending and descending flanks 10, 11 of the elements 7 present an increased angle towards the bottom parts 9. FIG. 3 is intended to show the continuous extension of a strengthening element 7 in the circumferential direction of the engine wall 2.

FIG. 4 presents an alternative embodiment in which the strengthening elements 12, with base portions 13 and top portions 14 have opposite ascending and descending flanks 15, 16 with a constant inclination angle α, in this case approximately 45°, in relation to the underlying surface. The individual strengthening elements 12 may or may not be interconnected at their base portions 11. In the given example, however, they are interconnected, preferably along the major part or the whole length of said elements 12.

FIG. 5 shows another embodiment of the invention, according to which each strengthening element 17, with a base portion 18 and a top portion 19, presents two opposite flanks 20, 21, only one of which 21 slopes with an inclination angle towards the underlying surface in order to contribute to the inventive design and an increased view factor of said elements 17. In the shown example, there is a gap between the individual neighbouring elements 17. However, as an alternative, some or all of said elements 17 may be interconnected at their base portions 19 as described above for the embodiments of FIGS. 2-4.

FIG. 6 shows yet another embodiment of inventive strengthening elements 22, provided with base portions 23, top portions 24 and opposite flanks 25, 26. Also in this embodiment, there is an optional gap between the base portion of neighbouring elements 22. However, this embodiment differs from that of FIG. 5 in that both of the opposite flanks 25, 26 of said elements have a sloping inclination angle, resulting in an increased view factor with regard to the previous embodiment.

FIG. 7 shows yet another embodiment of the invention, differing from the embodiment of FIG. 6 in that the strengthening elements 27 are interconnected at their base portions 28, preferably along the whole length of said elements 27. Thereby an even further improved heat transfer from the wall 2 is achieved.

Finally, FIG. 8 shows a further embodiment of the invention, according to which the individual strengthening elements 29 present opposite flanks 30, 31 that descends or ascends in a stepwise manner. The base portions 32 of the embodiment shown in FIG. 8 are not interconnected with each other. Such interconnection is, however, an option, in accordance with the teaching of the invention. It should also be understood that, as an alternative, only one out of the two opposite flanks may me designed in the suggested way.

It should be understood that the above embodiments have been described by way of example, and that alternative embodiments will be obvious for a person skilled in the art. Accordingly, the scope of protection is defined in the appended claims, though supported by the annexed drawings and the above description. In particular it should be mentioned that embodiments which combine the teaching of the above embodiments are within the scope of the invention, and that, accordingly individual strengthening elements may be of different design, provided that at least one or more thereof present the features defined by appended claims.

The inventive strengthening elements are not limited to be applied on an engine wall of the design shown in FIG. 3. On the contrary, the engine wall configuration may for example comprise an outer, cylindrical shroud (cover jacket) and a plurality of individual coolant tubes attached in a side-by-side relationship to the interior surface of the shroud, while the strengthening elements are applied on the exterior surface of the shroud in the above described way. Further, the strengthening elements may be applied to a wall lacking any cooling ducts/tubes.

Further, the invention is not limited to applications in a rocket wall, but it may for example also be applied in a wall of a satellite thruster or in an aircraft engine, such as in the combustion chamber wall, or a rear turbine housing wall.

1. A wall (2) configured to withstand a high thermal load, said wall (2) having a surface that is turned away from a heat source and provided with at least one strengthening element (7, 12, 17, 22, 27, 29) that, from a base portion thereof, protrudes from said surface, characterised in that said at least one strengthening element (7, 12, 17, 22, 27, 29) presents a decreasing width from its base portion (8, 13, 18, 23, 28, 32) towards a top portion (9, 14, 19, 24, 33) thereof.

2. A wall according to claim 1, characterised in that said at least one strengthening element (7, 12, 17, 22, 27) presents a continuously decreasing width from its base portion (8, 13, 18, 23, 28) towards its top portion (9, 14, 19, 24).

3. A wall according to claim 1 or 2, characterised in that said at least one strengthening element (7, 12, 17, 22, 27, 29) has two opposite flanks (10, 11, 15, 16, 20, 21, 25, 26, 30, 31) extending from the top portion (9, 14, 19, 24, 33) towards the base portion (8, 13, 18, 23, 28, 32), and that at least one (10, 11; 15, 16; 21; 25, 26; 30, 31) of said flanks slopes towards the base portion (8, 13, 18, 23, 28, 32).

4. A wall according to claim 1, characterised in that said at least one strengthening element (29) presents a stepwise decreasing width from its base portion (32) towards its top portion (33).

5. A wall according to any one of claims 1-4, characterised in that said at least one strengthening element (7, 12, 17, 22, 27, 29) presents a decreasing width along substantially the entire extension of the strengthening element from its base portion to its top portion.

6. A wall according to any one of claims 1-5, characterised in that the view factor of said at least one strengthening element (7, 12, 17, 22, 27, 29) is 0.7 or more.

7. A wall according to any one of claims 1-6, characterised hi that it comprises at least two neighbouring strengthening elements (17; 22; 29), wherein there is a gap between the base portions of said elements (17; 22; 29).

8. A wall according to any one of claims 1-6, characterised in that it comprises at least two neighbouring strengthening elements (7; 12; 27), wherein said elements are joined at their base portions (8; 13; 28).

9. A wall according to claim 8, characterised in that said at least two neighbouring strengthening elements (7; 12; 27) are joined at their base portions (8; 13; 28) along a major part of said elements (7; 12; 27) in a longitudinal direction thereof.

10. A wall according to claim 8 or 9, characterised in that said at least two neighbouring strengthening elements (7; 12; 27) are joined at their base portions (8; 13; 28) along generally the whole length of said elements (7; 12; 27).

11. A wall according to any one of claims 1-10, characterised in that said wall is annular and that said at least one strengthening element (7, 12, 17, 22, 27, 29) defines a flange that extends in a circumferential direction on said wall (2), crosswise to a flow direction of hot gases through said channel.

12. A wall according to claim 11, characterised in that said at least one strengthening element (7, 12, 17, 22, 27, 29) extends continuously along the outer periphery of said wall (2), thereby defining a ring-shaped element.

13. A wall according to any one of claims 1-12, characterised hi that it comprises at least two neighbouring strengthening elements (7; 12; 17; 22; 27; 29) that extend generally in parallel with each other.

14. A wall (2) according to claim any one of claims 1-12, characterised in that it comprises a plurality of strengthening elements (7, 12, 17, 22, 27, 29) and that said strengthening elements (7, 12, 17, 22, 27, 29) covers a substantial part of said surface.

15. A wall (2) according to any one of claims 1-12, characterised in that it comprises a plurality of strengthening elements (7, 12, 17, 22, 27, 29) and that said strengthening elements (7, 12, 17, 22, 27, 29) covers all of said surface.

16. A wall (2) according to any one of claims 1-15, characterised in that said at least one strengthening element (7, 12, 17, 22, 27, 29) is coated with a layer that increases the thermal emissivity thereof.

17. A wall (2) according to any one of claims 1-16, characterised in that the thermal emissivity of said at least one strengthening element (7, 12, 17, 22, 27, 29) is above 0.75.

18. A wall according to any one of claims 1-17, characterised in that the material of said at least one strengthening element (7, 12, 17, 22, 27, 29) has a higher thermal conductivity than the material of the part (4) of the wall (2) from which it protrudes.

19. A wall (2) according to any one of claims 1-18, characterised in that the part (4) of the wall (2) to which said at least one strengthening element (7, 12, 17, 22, 27, 29) is attached comprises steel and that said strengthening element (7, 12, 17, 22, 27, 29) comprises copper as a main constituent.

20. A wall (2) according to any one of claims 1-19, characterised in that it is an engine wall designed so as to delimit a channel in which there is a flow of hot gases during engine operation, said hot gases forming said heat source.

21. A wall (2) according to any one of claims 1-20, characterised in that it comprises a plurality of cooling ducts (6).

22. A wall (2) according to any one of claims 1-21, characterised in that it defines a thrust nozzle wall of a rocket engine.

23. A rocket engine, characterised in that it comprises a wall (2) according to any one of claims 1-22.
